(19) United States
(12) Patent Application Publication
(10) Pub. No.: US 2010/0084115 A1
(43) Pub. Date: Apr. 8, 2010

(54) Air Conditioning System for Vehicles

(75) Inventor: Nak Sup Sung, Hwangsung-si (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/400,501

(22) Filed: Mar. 9, 2009

(30) Foreign Application Priority Data
Oct. 6, 2008 (KR) 10-2008-0097590

(51) Int. Cl. B60H 1/00; F25B 29/00

(52) U.S. Cl. 165/63

(57) ABSTRACT

An air conditioning system for vehicles is provided to include an evaporator, a heating unit, and a case having a passage to fluidly-communicate between inside and outside the vehicle and including the evaporator and the heating unit in series therein, wherein the heating unit is pivotally coupled to the case and configured to control flow direction of air flowing from the evaporator through the passage.

### CROSS-REFERENCE TO RELATED APPLICATION

The present application claims priority to Korean Patent Application Number 10-2008-0097590 filed Oct. 6, 2008, the entire contents of which is incorporated herein for all purposes by this reference.

### BACKGROUND OF THE INVENTION

1. Field of the Invention

The present invention relates to an air conditioning system for vehicles.

2. Description of Related Art

In general, air conditioners for vehicles are apparatuses for cooling or heating the interior of the vehicle in the summer or winter, or for defrosting the windshield on rainy days or in the winter so as to enable a driver to secure front and rear visibility.

FIG. 1 is a cross-sectional view illustrating a conventional air conditioner for vehicles.

The air conditioner for vehicles includes an inside/outside air switching door 10 through which inside or outside air of a vehicle selectively passes, a blower 20 introducing the air into the air conditioner through the inside/outside air exchange door 10, an evaporator 30 through which the air introduced by the blower 20 passes while flowing along an air conditioner case 25, a mix door 40 converting the direction of the air flowing through the evaporator 30, a positive temperature coefficient (PTC) heater 50 installed below the mix door 40 and using a PTC element as a heating element, and duct doors 62, 64 and 66 installed on three ducts leading from the air conditioner case 25 to the inside of the vehicle.

The mix door 40 is configured to rotate around a hinge axle 42 fixed to the case.

Further, an example of the PCT heater 50 is disclosed in Korean Patent No. 10-0575940.

The operation of the conventional air conditioner for vehicles having the aforementioned configuration will be described below.

When the inside/outside air switching door 10 is rotated such that the air conditioner communicates with the outside of the vehicle, the blower 20 is driven to draw the outside air.

The outside air drawn by the blower 20 passes through the evaporator 30. Generally, when the air conditioner is not operated, the air passing through the evaporator 30 is maintained at a room temperature since it is not cooled.

The mix door 40 is rotated at the request of a driver, thereby adjusting the direction of the air flowing through the evaporator 30. When the driver requests heating, the mix door 40 is rotated such that the air passes through the PTC heater 50 in part or in whole so as to be fitted to a requested heating temperature.

However, the conventional air conditioner for vehicles is restricted in installation because the mix door must be separately installed, and because the installed position or size of the PTC heater is restricted due to the mix door.

The information disclosed in this Background of the Invention section is only for enhancement of understanding of the background of the invention, and should not be taken as an acknowledgement or any form of suggestion that this information forms the prior art that is already known to a person skilled in the art.

### BRIEF SUMMARY OF THE INVENTION

Various aspects of the present invention are directed to provide an air conditioning system for vehicles, which maintains heating and cooling functions without separately installing a mix door, and which reduces restrictions on the installation position or size of a positive temperature coefficient (PTC) heater.

In an aspect of the present invention, an air conditioning system for a vehicle may include an evaporator, a heating unit, and a case having a passage to fluidly-communicate between inside and outside the vehicle and including the evaporator and the heating unit in series therein, wherein the heating unit is pivotally coupled to the case and configured to control flow direction of air flowing from the evaporator through the passage, wherein the heating unit is configured to control temperature and/or flow amount of the air.

In another aspect of the present invention, the air conditioning system further includes at least a duct passage fluidly-communicating with the passage of the case wherein the heating unit is disposed between the evaporator and the duct passage and configured to control flow direction of the air to the respective duct passage.

Rotational axis of the heating unit may be disposed on an end portion thereof or passing therethrough.

The air conditioning system may include at least two heating units, wherein the heating units are installed in parallel along the passage and/or in series at a portion of the passage.

The heating unit may be a positive temperature coefficient heater.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view illustrating a conventional air conditioner for vehicles.

FIG. 2 is a cross-sectional view illustrating an air conditioning system for vehicles according to an exemplary embodiment of the present invention.

FIGS. 3A and 3B are partial cross-sectional views illustrating variations of the PTC heater of FIG. 2.

FIGS. 4A and 4B are cross-sectional views illustrating other variations of the PTC heater of FIG. 2.

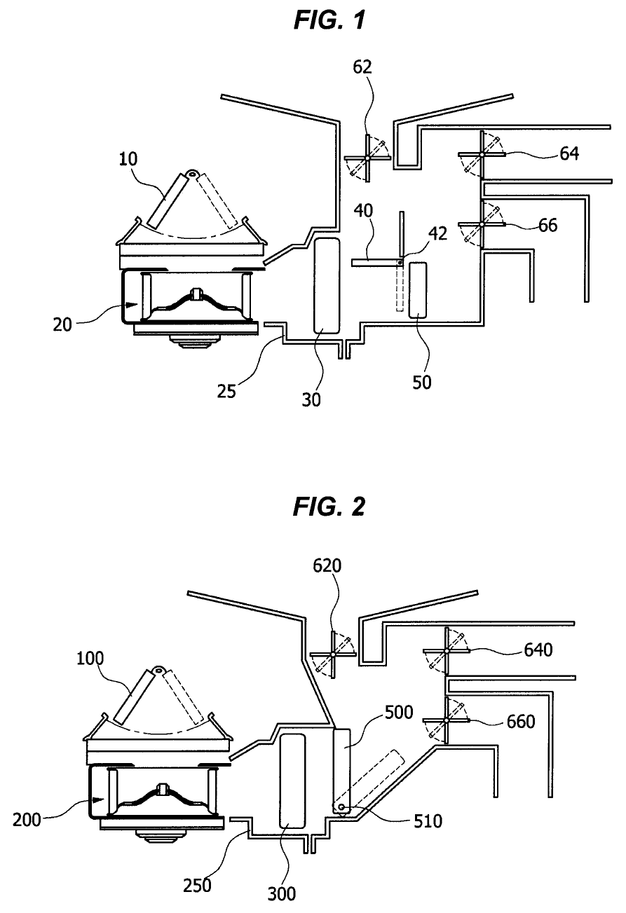

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

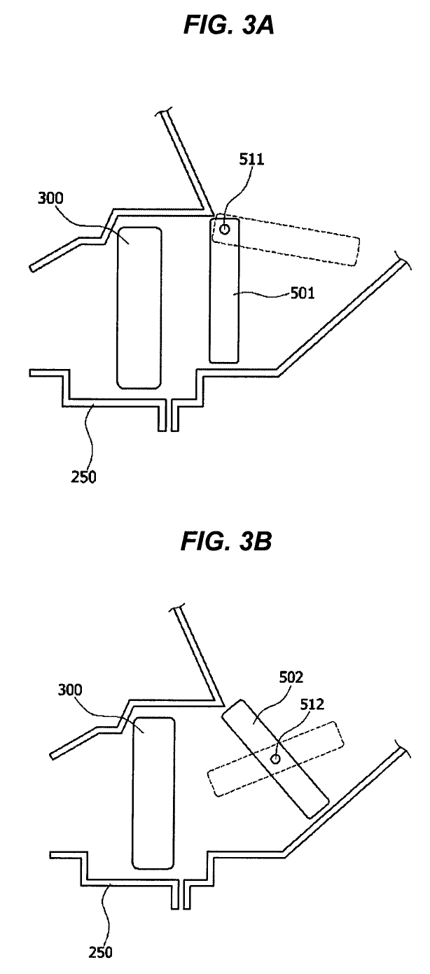

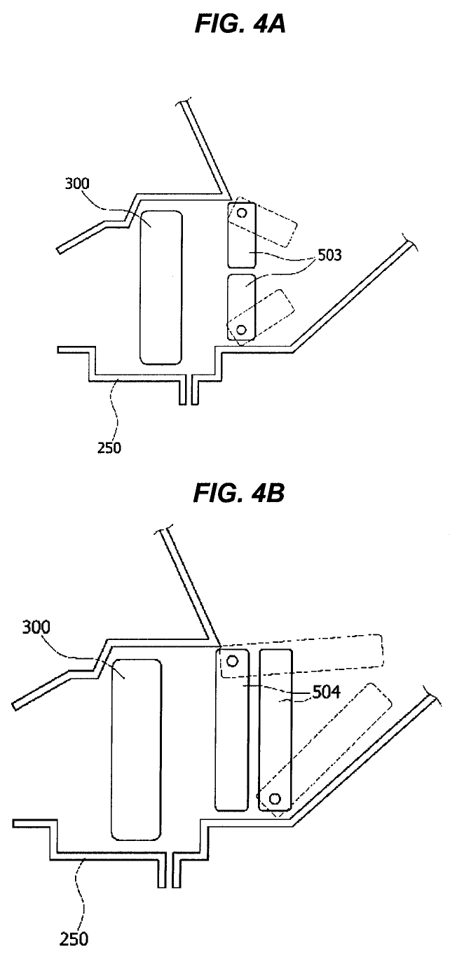

FIG. 2 is a cross-sectional view illustrating an air conditioning system for vehicles according to an exemplary embodiment of the present invention. FIGS. 3A and 3B are partial cross-sectional views illustrating variations of the PTC heater of FIG. 2. FIGS. 4A and 4B are cross-sectional views illustrating other variations of the PTC heater of FIG. 2.

In the air conditioning system for vehicles according to an exemplary embodiment of the present invention, an evaporator 300 and a positive temperature coefficient (PTC) heater 500 are installed in a case 250. The PCT heater 500 is rotated around a hinge axle 510 fixed to the case 250 so as to open or close a passage in the case 250 through which air passing through the evaporator 300 flows.

In detail, the air conditioning system for vehicles includes an inside/outside air switching door 100 through which inside or outside air of the vehicle selectively passes, a blower 200 introducing the inside/outside air into the air conditioning system through the inside/outside air exchange door 100, an evaporator 300 through which the air introduced by the blower 200 passes while flowing along a passage in a case 250, a positive temperature coefficient (PTC) heater 500 receiving the air passing through the evaporator 300 and using a PTC element as a heating element, and duct doors 620, 640 and 660 installed on three ducts leading from the case 250 to the inside of the vehicle.

The PTC heater 500 serves to open or close the passage in the case 250 through which the air from the evaporator 300 flows. The hinge axle 510 is fixed to the case 250, and is coupled to a lower portion of the PTC heater 500, and thus the PTC heater 500 is rotated around the hinge axle 510.

The hinge axle 510 can be coupled to the PTC heater 500 in various ways. For example, as in FIG. 3A, the hinge axle 511 is coupled to an upper portion of the PTC heater 501. Further, as in FIG. 3B, the hinge axle 512 is coupled to a middle portion of the PTC heater 502.

Thus, the PTC heater can be designed to be compatible with a structure of the vehicle or its air conditioning system by variously changing a position where the hinge axle is coupled to the PTC heater.

Further, if necessary, the PTC heater can be modified. For example, as in FIGS. 4A and 4B, there are installed with a plurality of PTC heaters 503 and 504. Furthermore, the plurality of PTC heaters 503 and 504 are installed in parallel or in series.

In the case in which the PTC heaters are installed, a rate at which temperature is increased by the PTC heaters becomes high, or the PTC heaters have various layout designs.

The operation of the air conditioning system having the aforementioned configuration will be described below.

The PTC heater and the hinge axle will be described on the basis of those illustrated in FIG. 2.

When the air conditioning system for vehicles is operated, the outside or inside air of the vehicle flows into the air conditioning system through the blower 200.

The air introduced by the blower 200 passes through the evaporator 300. Generally, when the air conditioning system is not operated, the air passing through the evaporator 300 is maintained at a room temperature since it is not cooled. In contrast, when the air conditioning system is operated, the air passing through the evaporator 300 is cooled.

Meanwhile, the PTC heater 500 is rotated around the hinge axle 510 at the request of a driver, thereby opening or closing the passage in the case 250 through which the air from the evaporator 300 flows.

Thus, while the air passes through the PTC heater 500 in part or in whole, the temperature of the air is increased. Thereby, the air having the temperature that meets the heating request of the driver flows into the inside of the vehicle through the duct doors 620, 640 and 660.

As described above, according to various embodiments of the present invention, the air conditioning system for vehicles can introduce the air having the temperature that meets the heating request of the driver into the inside of the vehicle without installing a mix door.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air conditioning system for a vehicle, comprising:
an evaporator;
a heating unit; and
a case having a passage to fluidly-communicate between inside and outside the vehicle and including the evaporator and the heating unit in series therein,
wherein the heating unit is pivotally coupled to the case and configured to control flow direction of air flowing from the evaporator through the passage.

2. The air conditioning system according to claim 1, wherein the heating unit is configured to control temperature and/or flow amount of the air.

3. The air conditioning system according to claim 1, further comprising at least a duct passage fluidly-communicating with the passage of the case wherein the heating unit is disposed between the evaporator and the duct passage and configured to control flow direction of the air to the respective duct passage.

4. The air conditioning system according to claim 1, wherein rotational axis of the heating unit is disposed on an end portion thereof or passing therethrough.

5. The air conditioning system according to claim 4, comprising at least two heating units.

6. The air conditioning system according to claim 5, wherein the heating units are installed in parallel along the passage and/or in series at a portion of the passage.

7. The air conditioning system according to claim 1, comprising at least two heating units.

8. The air conditioning system according to claim 7, wherein the heating units are installed in parallel along the passage and/or in series at a portion of the passage.

9. The air conditioning system according to claim 1, wherein the heating unit is a positive temperature coefficient heater.
